(19) United States
(12) Patent Application Publication
(10) Pub. No.: US 2018/0260484 A1
(43) Pub. Date: Sep. 13, 2018

(54) Method, Apparatus, and Device for Generating Hot News

(71) Applicant: Guangzhou Shenma Mobile Information Technology Co., Ltd., Guangzhou (CN)

(72) Inventor: Kun WANG, Guangzhou (CN)

(21) Appl. No.: 15/912,964

(22) Filed: Mar. 6, 2018

(30) Foreign Application Priority Data
Mar. 7, 2017 (CN) CN201710127532.5

(51) Int. Cl. G06F 17/30

(52) U.S. Cl. CPC G06F 17/30867; H04L 67/42; G06F 17/3053; G06F 17/30598

(57) ABSTRACT

The present application discloses a method, a device and an electronic apparatus for generating hot news. According to one embodiment of the invention, the heat parameter of a news piece can be determined by taking into account the timeliness and the content of the news. A method of generating hot news is disclosed to include the following steps: a timeliness parameter of a piece of news is first determined, where the timeliness parameter indicates that the heat parameter of the news decreases over time; a content heat parameter of the news is also determined, where the content heat parameter is determined based on the content of the news; and based on a weighted sum of the timeliness parameter and the content heat parameter, the heat parameter of the news is determined to generate hot news.

### PRIORITY CLAIMS

This present application claims priority under the Paris Convention to Chinese Patent Application No. 201710127532.5 filed on Mar. 6, 2017, and titled Method, Apparatus and Electronic Device for Generating Hot News, the entire content of which is incorporated herein by reference.

### FIELD OF THE INVENTION

The present disclosure relates generally to information technology, and, more specifically, to methods, apparatus and electronic devices for generating hot news.

### BACKGROUND OF THE INVENTION

A piece of hot news is information that the public pays attention to. A content provider often estimates what information may be of interest to users using different methods and provide the information to the users as hot news. This allows the content provider to retain users and improve customer loyalty. The heat parameter of a piece of news or the “hotness” of a piece of news refers to the level of attention the news piece attracts.

Generally, hot news is widely disseminated or anxiously anticipated and has a strong timeliness. In the prior art, hot news is usually collected and sorted manually. This approach can ensure the quality of the news under limited circumstances. However, this approach requires a large amount of human labor, and its timeliness is relatively poor. This approach cannot meet the needs of users who want to receive timely news.

In addition, technicians in this field have been trying to come up with new technical solutions for generating hot news.

For example, Chinese patent application CN201410181773.4 discloses a news recommendation method and device. The patent application is incorporated herein by reference. Chinese patent application CN201210079091.3 discloses a hot information mining method and system, and is incorporated herein by reference. Chinese patent application CN20111031808030.3 discloses a method and system for displaying microblog hot data, and is incorporated herein by reference.

New technical solutions are needed to solve at least one of the technical problems mentioned above.

### SUMMARY OF THE INVENTION

The present disclosure teaches new technical solutions on how to generate hot news in a timely fashion.

According to a first embodiment, a method of generating hot news is provided. The method includes the following steps: (a) determining a timeliness parameter of a piece of news in a plurality of pieces of news, where the timeliness parameter indicates that the heat parameter of the news decreases as time goes by; (b) determining a content heat parameter of each piece of news, where the content heat parameter is determined based on the content of the news; and (c) based on the weighted sum value of the timeliness parameter and the content heat parameter, the heat parameter of each piece of news is determined to generate hot news.

Optionally or alternatively, the timeliness parameter decreases exponentially with time. The timeliness parameter of a piece of news can be represented as:

NewsTimeScore=exp(−r*t),

where NewsTimeScore denotes the normalized timeliness parameter, r denotes an attenuation constant, t denotes the time and t=0 when the piece of news is issued.

Optionally or alternatively, the content heat parameter is based on the heat parameter of a hot word contained in the piece of news. In some embodiments, the heat parameter of a hot word can be expressed as:

$$WordHotScore ( word ) = sqrt ( \frac{num ( word )}{MaxNum} ) ,$$

where WordHotScore (word) denotes the heat parameter of the hot word ‘word’, num (word) denotes the occurrence times of the hot word in the piece of news, and MaxNum denotes the occurrence times of the most-occurred hot word in the piece.

The content heat parameter is represented as:

$$NewsHotScore ( news ) = \frac{{Σ}_{word} WordHotScore ( word )}{Num} ,$$

where NewsHotScore (news) denotes the content heat parameter of the news, Σ_{word}WordHotScore(word) denotes the total value of the heat parameter of multiple hot words in the news, and Num denotes the number of hot words in the news.

In some embodiments, the heat parameter of the news can be calculated as a weighted sum of NewsTimeScore and NewsHotScore as follows:

HotScore=α*NewsTimeScore+(1−α)*NewsHotScore,

where, HotScore denotes the heat parameter of the news, α is a weighting factor.

Optionally or alternatively, the described methods also include dividing a plurality of news into a plurality of news clusters by calculating a similarity among the plurality of pieces of news. A heat parameter of the news cluster can be calculated based on the heat parameter of each piece of news in the news cluster. The hot words in the news cluster are extracted as the event attributes of the news cluster, and hot news is generated based on at least one of the heat parameter and event attributes of the news cluster.

Optionally or alternatively, the heat parameter of the news cluster is an average of the heat parameter of each piece of news it contains.

Optionally or alternatively, one or more hot words with the highest heat value in the news cluster are extracted as attributes of the news cluster.

Optionally or alternatively, the generated hot news is a piece of news in the news cluster.

Optionally or alternatively, the generated hot news contains one or more of the event attributes (e.g., hot words), but does not belong to the news cluster.

Optionally or alternatively, a plurality of news articles or pieces is divided into a plurality of news clusters in the following steps. The first step is to randomly select one piece of news as seed news from a plurality of news in the most recent time period. The second step is to search for N pieces of news that are the most similar to the seed news and determine a similarity S between each of the N pieces of news and the seed news. The third step is to determine M1 pieces of news, each of which has a similarity S greater than the first threshold THs1. In the fourth step, the M1 pieces of news are identified as a candidate news cluster when M1 is greater than the second threshold THm1. For the rest pieces of the news, i.e., excluding the M1 pieces, steps one through four are repeated until no new news cluster is produced and K1 news clusters are obtained.

Optionally or alternatively, division of a plurality of pieces of news into a plurality of news clusters further includes the following steps: (a) a K-means clustering operation is performed on the K1 news cluster; (b) performing a filtering process on the K1 news cluster, where the filtering process comprises at least one of the following operations: (i) removing the news in each news cluster that has a centroid similarity with the news cluster lower than the third threshold THs2, and (ii) removing the news cluster that has a number of news pieces (M2) fewer than the fourth threshold THm2.

Optionally or alternatively, the K-means clustering operation and the filtering process are repeatedly performed, to obtain K2 news clusters.

Optionally or alternatively, the plurality of news is the news generated during the most recent time period.

According to a second embodiment, a hot-news generation apparatus includes: a device for determining a timeliness parameter for each piece of news in a plurality of pieces of news, wherein the timeliness parameter indicates a decrease in the heat parameter of the news over time; a device for determining a content heat parameter for each piece of news, wherein the content heat parameter is a parameter determined based on the content of the news; and a device for determining a heat parameter of each piece of news to generate hot news based on the weighted sum of the timeliness parameter and the content heat parameter.

According to a third embodiment, an electronic apparatus is provided that includes a hot news generation device for generating hot news, and is designed to perform a method of generating hot news according to the methods described above.

According to a fourth embodiment, an electronic apparatus is provided. The electronic apparatus comprises a processor and a memory. The memory is used to store instructions, and the instructions are used to control the processor to execute a method of generating hot news according to the methods described above.

Optionally or alternatively, the electronic apparatus is a server that transmits generated hot news to a client device over a network.

According to another embodiment, the heat parameter of the news can be determined by taking into account the timeliness and the content heat parameter of the news for generating hot news.

Other features and advantages of the technical solutions in the present disclosure will become clearer in the following detailed description of exemplary embodiments with reference to the accompanying drawings.

### DESCRIPTION OF THE DRAWINGS

Exemplary embodiments are illustrated in the drawings that are combined with the description to form part of the specification. Embodiments are used together with the description to explain the principles of the present invention.

FIG. 1 is a schematic flowchart of a method for generating hot news according to one embodiment.

FIG. 2 is a schematic block diagram of an electronic device according to a second embodiment.

FIG. 3 is a schematic block diagram of an electronic device according to a third embodiment.

FIG. 4 is a schematic diagram of a hot news system according to a fourth embodiment.

FIG. 5 is a schematic graph of the timeliness parameters of a piece of hot news according to a fifth embodiment.

### DETAILED DESCRIPTION

A variety of exemplary embodiments will now be described in detail with reference to the accompanying drawings. It should be noted that, unless otherwise expressly stated, the relative arrangements, digital implementation, mathematical expressions, values of the components and operational steps described in these embodiments are not intended to limit the scope of the inventions.

The following description of exemplary embodiments is merely illustrative and shall not be interpreted as limiting on the present inventions and their applications or usage.

Technologies, methods, and devices known to ordinarily skilled technicians in relevant fields may be omitted, but where appropriate, such technologies, methods and devices shall be considered as being incorporated as part of the specification.

In all the examples shown and discussed here, any numeric value shall be interpreted as merely illustrative, not restrictive or limiting. Thus, other exemplary embodiments can have values different from what are suggested herein.

It should be noted that similar labels and letters represent similar items in the accompanying drawings below. Once an item is defined in a reference figure, it may be omitted in further discussions of subsequent reference figures.

The timeliness of a piece of news is an important attribute of the news. In some embodiments, a piece of hot news is generated based on the timeliness of a plurality of hot news and the content information of the plurality of hot news.

Alternatively, a new scheme for classifying and/or clustering a variety of news articles or pieces is also proposed in embodiments described below.

Through the teachings of the present disclosure, the time lag in distributing hot news can be prevented or minimized to a certain extent. According to some embodiments disclosed herein, the efficiency of discovering and distributing hot news can be improved. Also, user experience can be enhanced to a certain extent through the technical solutions taught in some embodiments disclosed herein.

Below, some of the terms used in the present disclosure are explained.

News clusters are news collections formed by clustering and/or classifying methods. In some embodiments, a news cluster can be about a specific event. For example, each news cluster can represent a possible hot event that contains multiple stories.

The heat parameter of a piece of news indicates the level of attention the news is attracting. For example, if the heat parameter of the news is higher, the news is more likely hot news than a piece of news with a lower heat parameter.

The heat parameter of a news cluster or the heat parameter of an event indicates the level of attention the news cluster is attracting. For example, the heat parameter of the news cluster is determined by the heat parameter of all the news belonging to the news cluster.

An event attribute of a news cluster is a keyword that can represent the key information of the news cluster. A news cluster can have more than one event attribute.

Next embodiments and examples are described with reference to the accompanying drawings.

<Method>

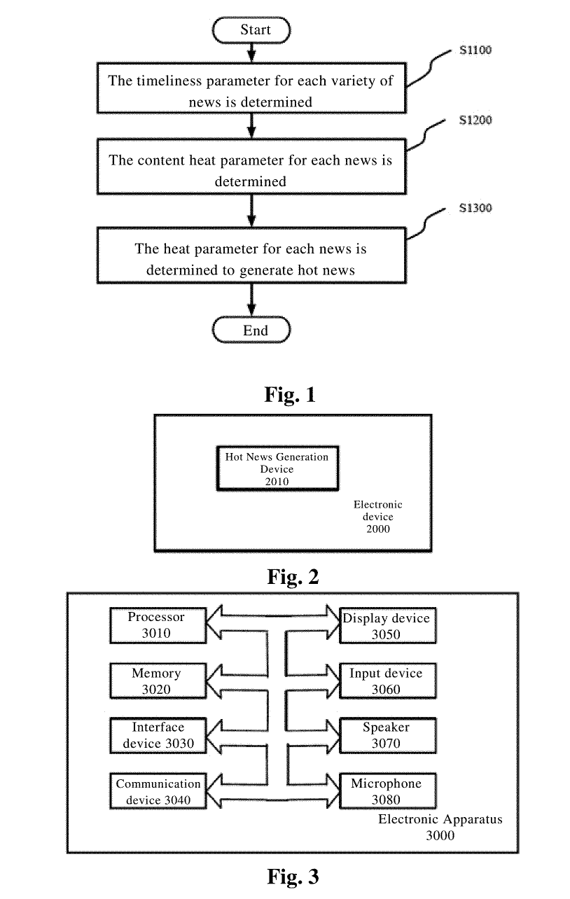

FIG. 1 shows a schematic flow chart of a method of generating hot news according to one embodiment.

In step S1100, a timeliness parameter of each piece of news in multiple pieces of news is determined, wherein the timeliness parameter indicates that the heat parameter of the news decreases as time goes by; For example, the multiple pieces of news are those generated during the most recent time period.

In one example, the timeliness parameter decreases exponentially over time. For example, the timeliness parameter is represented as:

NewsTimeScore=exp(−r*t) (Formula 1),

where NewsTimeScore denotes the normalized timeliness parameter, r denotes an attenuation constant, t denotes the time and t=0 when the news is released.

The r value may be set as desired or based on experience. For example, assuming that the value of the timeliness parameter of the news at the time of release is 1, and that the timeliness parameter is attenuated to 0.01 after 48 hours, r would be 0.0954 in this case. FIG. 5 shows a schematic graph of the timeliness parameters of the hot news in this example.

In step S1200, a content heat parameter of each piece of news is determined, wherein the content heat parameter is determined based on the content of the news.

Here, the content heat parameter may be determined using prior art methods. For example, the content heat parameter may be manually set. Alternatively, the content heat parameter may be determined based on the number of hits on the news made by users.

In one example, the content heat parameter may be based on the heat parameter of a hot word contained in the news. For example, the heat parameter a hot word can be calculated as:

$$WordHotScore ( word ) = sqrt ( \frac{num ( word )}{MaxNum} ) , \qquad ( Formula 2 )$$

where WordHotScore (word) denotes the heat parameter of the hot word, num (word) denotes the occurrence times of the hot word, and MaxNum denotes the occurrence times of the most occurred hot word. For example, in some cases, the hot word that appears most frequently may not belong to the multiple pieces of news, and may be based on hot words found through searching on the Internet.

The content heat parameter is represented as:

$$NewsHotScore ( news ) = \frac{{Σ}_{word} WordHotScore ( word )}{Num} , \qquad ( Formula 3 )$$

where NewsHotScore (news) denotes the content heat parameter of a piece of news, Σ_{word}WordHotScore(word) denotes the total heat value of the hot words contained in the piece of news, and Num denotes the number of hot words in that piece.

In step S1300, based on the weighted sum value of the timeliness parameter and the content heat parameter, the heat parameter of each piece of news is determined to generate hot news.

In one example, the weighted sum value may be determined based on the preceding Formula 1-3. For example, the heat parameter of the news is represented as follows:

HotScore=α*NewsTimeScore+(1−α)*NewsHotScore (Formula 4),

where HotScore denotes the value of the heat parameter of the news, α being a weighting factor.

In an embodiment, both timeliness parameters and content heat parameters are evaluated as two parallel factors to determine the heat parameter of the news. In this way, we can minimize or reduce the influence of abnormal change of one of the parameters on the heat parameter of the news. In this way, for example, situations in which news has occurred a long time ago (NewsTimeScore is small) or news has just happened (NewsHotScore is large) can be dealt with properly.

In addition to determining the heat parameter for a single piece of news and generating a piece of hot news, the present disclosure also proposes generating hot news based on news clusters. Because news clusters can reflect more comprehensive information, this approach also improves the accuracy of generating hot news to a certain extent. In the field of information technology, user experience is an important aspect of the product. The methods disclosed herein improve user experience.

In another embodiment, the method of generating hot news also includes dividing multiple pieces of news into a plurality of news clusters by calculating the similarity among the multiple pieces of news. The heat parameter of a news cluster is obtained based on the heat parameter of each piece of news in the news cluster, extracting hot words in the news cluster as the event attribute of the news cluster, and generating hot news based on at least one of the heat parameter and event attributes of the news cluster.

For example, the heat parameter of the news cluster is an average of the heat parameter of the pieces of news it contains. For example, a variety of hot words with the highest heat value in the news cluster is extracted as event attributes of the news cluster.

The generated hot news may be news belonging to the news cluster.

For example, the generated hot news may be the news piece in a news cluster with the highest heat parameter.

Optionally, log information may be received from a user when the user logs onto a client machine. For example, the log information contains the content of a web page frequently visited by the user. Based on the log information, the event attribute of a news cluster is utilized to obtain one or more news clusters that may be of interest to the user. One or more news articles with high heat parameter value in the one or more news clusters are selected to be recommended to the user.

Alternatively, the generated hot news may contain one of the event attributes of the news cluster but does not belong to the news cluster. For example, the event attribute can be acquired in the manner described earlier, and the corresponding hot news to be provided to the user is retrieved on a network or from the Internet based on the event attribute.

In another embodiment, a variety of news articles or pieces are divided into multiple news clusters in a heuristic manner. The method includes, for example, the first step of randomly selecting a news piece from a variety of news pieces in the most recent time period as seed news. The second step in the method is to search for N pieces of news that are most similar to the seed news and determine a similarity S between each of the N pieces of news and the seed news. The third step is to determine M1 pieces of news whose similarity S is greater than the first threshold THs1. In the fourth step, the M1 pieces of news are grouped into a candidate news cluster if M1 is greater than the second threshold THm1. Steps one to four can be repeated for the rest of the news pieces until no new news cluster can be generated and K1 news cluster are obtained.

In the above embodiment, in the first and second steps, one piece in the plurality of news is acquired as seed news and N pieces of news similar to the seed news are identified, then the similarity S between the seed news and each piece of the N pieces news is determined. For example, a piece of news generated within the last six hours can be selected as seed news at random. Then, N pieces of news that are most similar to the seed news are identified and the similarity between each piece of news and the seed news is determined. Based on the similarity S and the corresponding number of pieces of news, one or more candidate news clusters are determined.

Based on the teachings of the present disclosure, technicians can use a variety of methods or approaches to estimate similarity. For example, multiple keywords may be extracted from each news item, and the similarity of the two news items may be determined by the number of overlapping keywords. Similarity may be determined in other ways as taught in the prior art. Also, N, THs1, THm1 values can be derived from past experience, for example, N=100, THs1=0.3 (for example, 30% of the keywords in the two stories coincide, etc.), THm1=10. In this way, multiple news clusters can be obtained or generated quickly.

The K1 news clusters selected above can be used directly as final news clusters. In addition, K-means clustering operation may be performed on the K1 news clusters. When using a K-means clustering method to process multiple news clusters, how to obtain the initial K value is a problem facing technicians in this field. The initial K value can be quickly determined in the manner described above. In addition, the plurality of news in the initial news cluster obtained in the above manner already has similarities, which can reduce the amount of processing in a K-means clustering operation.

K-means clustering operation is known to those skilled in the art. According to the teachings of the present disclosure, a K-means clustering operation can be used in the technical solutions of generating hot news disclosed herein, to improve accuracy.

In another embodiment, K-means clustering operation can be further improved. For example, after a K-means clustering operation is performed on the K1 news cluster, a filtering processing is performed on the K1 news cluster. The filtering process comprises at least one of the following operations: removing a piece of news having a centroid similarity less than a third threshold THs2 from each news cluster, and removing a news cluster that has M2 pieces of news, where M2 is fewer than the fourth threshold THm2.

In some embodiments, the K-means clustering operation and the filtering process may be repeated to obtain K2 news clusters. For example, the value of K2 may be set by an operator. Alternatively, K2 may be a stable value reached by the K-means clustering operations.

In some embodiments, the values of THs2 and THm2 can be set based on experience. In one example, THs2=0.4 (i.e., 40% of the keywords in the two stories coincide), THm2=5. Of course, THs2 and THm2 can also be set to the same values as THs1 and THm1 respectively. In this way, the accuracy of the acquired news clusters can be further improved.

<Device>

The technical personnel in this field should understand that, in the electronic technological field, the above-mentioned methods can be implemented through software, hardware, or a combination of software and hardware, and should be able to make hot news generation apparatus based on the methods disclosed herein. The apparatus may include a device for implementing a variety of operations in the methods of generating hot news disclosed herein. For example, the apparatus may include a device for determining a timeliness parameter for each piece of news, wherein the timeliness parameter denotes a decrease in the heat parameter of the news over time. The apparatus may further include a device for determining a content heat parameter for each piece of news. The content heat parameter is determined based on the content of the news. The apparatus also includes a device for determining a heat parameter for each piece of news based on a weighted sum of the timeliness parameter and the content heat parameter.

<Electronic Device>

Each embodiment of the invention may be implemented in an electronic device. The electronic device could be a computer, a server, etc. With the advancement of electronic technology, the functions of a client device or terminal has become more and more powerful. The electronic device can also be a client device or terminal, such as a notebook computer, a smart phone, a tablet computer, etc.

FIG. 2 is a schematic block diagram of an electronic device according to another embodiment of the present invention. As shown in FIG. 2, the electronic device 2000 includes the aforementioned hot news generation device 2010 for generating hot news. For example, the electronic device 2000 is a server that transmits generated hot news to a client device. Alternatively, the electronic device 2000 is a client device that generates hot news and presents the hot news to a user.

On the other hand, with the development of electronic information technology such as large-scale integrated circuit technology and the trend of software and hardware, it is difficult to clearly divide the software and hardware of a computer system. Often, an operation can be carried out by software or hardware. The execution of any instruction can be done either by hardware or software. To achieve a certain machine function, either hardware implementation or software implementation can be adopted, depending on factors such as price, speed, reliability, storage capacity, change cycle, and other non-technical factors. Thus, for ordinary technicians in the field of electronic information technology, one way of describing a technical scheme more directly and clearly is to describe the operations employed in the scheme. If technical aspects of an operation to be performed is known, a technician in the art may design the desired machine directly based on non-technical considerations. In this respect, an electronic device is also provided in another embodiment. The electronic device is designed to perform operations of generating hot news according to embodiments disclosed herein.

As shown in FIG. 3, the electronic apparatus 3000 may include a processor 3010, a memory 3020, an interface device 3030, a communication device 3040, a display device 3050, an input device 3060, a loudspeaker 3070, a microphone 3080, etc.

The processor 3010 may be, for example, a CPU, a microprocessor MCU, etc. The memory 3020 may include, for example, a ROM (read-only memory), a RAM (random access memory), and/or a non-volatile memory of a hard disk, etc. The interface device 3030 includes, for example, a USB interface, a headphone interface, etc.

The communication device 3040 may be configured to conduct, for example, wired or wireless communication.

The display device 3050 is, for example, a liquid crystal display screen, a touch display screen, etc. The input device 3060 may include, for example, a touch screen, a keyboard, etc. A user can input/output voice information via the loudspeaker 3070 and the microphone 3080.

The electronic apparatus shown in FIG. 3 is only illustrative and is by no means intended to restrict the methods, apparatus, applications or usages disclosed herein.

In some embodiments, the memory 3020 is used to store instructions that control the processor 3010 to perform a method of generating hot news described above with reference to FIG. 1. A technician in the art should understand that, although a variety of devices are shown in FIG. 3, some embodiments may require only some of the devices shown in FIG. 3, such as the processor 3010, the storage device 3020, and so on. The technical personnel may, in accordance with the schemes disclosed herein, design or provide control instructions to the electronic apparatus. Instructions on how to control the processor to operate are well known in the field and are not described in detail here.

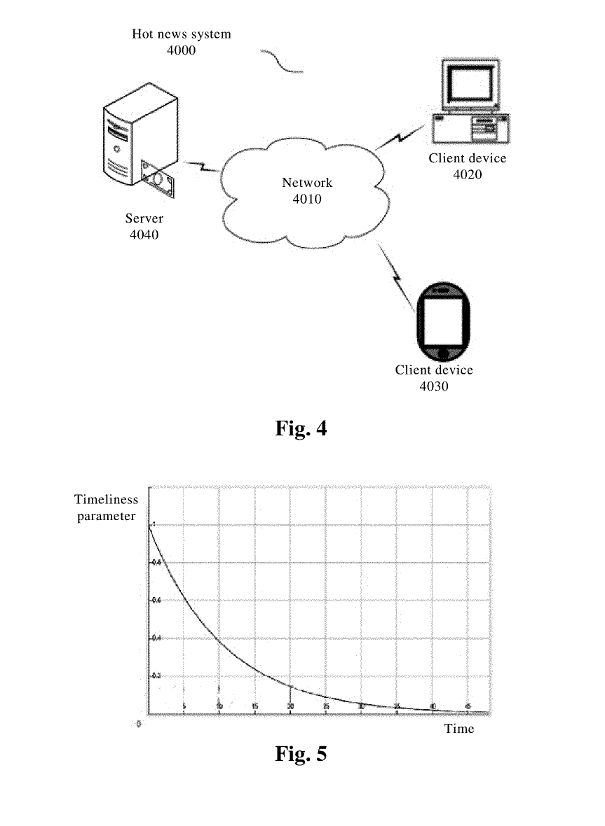

FIG. 4 is a schematic diagram of a hot-news generation system 4000 according to another embodiment of the present invention.

In this embodiment, the electronic apparatus is a server 4040 that transmits the generated hot news to client devices 4020, 4030, etc., over a network 4010.

### Example

Usually, when a news event occurs, there will be multiple news articles from multiple media reporting the same event from different angles in a short period of time. In such case, news clusters for the last six hours may be aggregated to obtain relevant or up-to-date news. The news clusters are then processed by K-means clustering, to generate a final set of news clusters of hot news. In a K-means clustering process, news clusters can be filtered, for example, to obtain the heat parameter and/or event attributes of the news clusters.

For example, the number of news articles generated in the last six hours is 10,000. The keywords in the news are extracted first. In the prior art, many schemes for extracting keywords are known. For example, words in a news headline can be extracted as keywords. Words repeated in the news body can be also extracted as keywords. For example, Rada Mihalcea and Paul Tarau et al., TextRank: Bringing Order into Texts (Association for Computational Linguistics, 2004); Stuart Rose et al.; Automatic Keyword Extraction from Individual Documents (Text Mining (2010): 1-20); Joel Nothman et al. “Learning Multilingual Named Entity Recognition from Wikipedia” (Artificial Intelligence 194 (2013): 151-175); and Rami Alrfou et al. “Polyglot-NER: Massive Multilingual Named Entity Recognition” (Proceedings of the 2015 SIAM International Conference on Data Mining, Vancouver, British Columbia, Canada. 2015) all disclose methods of extracting keywords, and all the articles are incorporated herein by reference. Since how to extract keywords is not the focus of the present disclosure, detailed description is therefore omitted herein.

Because the amount of news available varies at different times, it is difficult to determine the number of news clusters (i.e., news events) in advance. In this example, the 10,000 stories are divided into news clusters in a heuristic manner as described earlier.

Specifically, in the first step, obtain the first piece of news and N=100 pieces of news that are similar to it.

In the second step, a degree of similarity S between the first piece of news and each of the 100 pieces of news is determined.

In the third step, M1 pieces of news whose similarity S is greater than the first threshold THs1=0.3 are identified.

In the fourth step, the M1 pieces of news are grouped into a candidate news cluster when M1 is greater than the second threshold THm1=10. For example, M1=50.

Repeat steps one to four above for the remaining 99950 news articles. For example, K1=200 candidate news clusters are finally obtained. For example, the 200 news clusters may contain 3000 news articles.

The 200 news clusters are initial clusters for clustering operation and the number of initial clusters is 200.

A K-means clustering processing is carried out on the 200 news clusters. Since K-means clustering process is known in the prior art, it is not described in detail here.

In some embodiments, after or during the K-means clustering process, the intermediate clustering can be filtered after each clustering operation. For example, any news whose centroid similarity with the news cluster is lower than THs2=0.4 is removed; and a news cluster that, after removing the M2 pieces of news, has the number of news pieces fewer than the fourth threshold THm2=5 is removed. In this way, the news cluster and the news in each cluster can be further simplified. For example, after the filtering process, K2=150 news clusters are obtained.

Next, the heat parameter of each news cluster is calculated. The heat parameter of a news cluster is based on the heat parameter of the news pieces it contains. The heat parameter of a piece of news is based on the timeliness parameter and content heat parameter calculated for that piece.

For example, FIG. 5 is a schematic graph of how the timeliness parameter of the news changes over time according to another embodiment. In this example, the timeliness parameter is assumed to be 1 when the news is just released, and the timeliness parameter is reduced to 0.01 after 48 hours. The timeliness parameters can be represented as:

NewsTimeScore=exp(−0.0954*t) (Formula 5).

An exemplary method of determining the content heat parameter of a news piece is described next. The content heat parameter may be based on the heat parameter of the hot words contained in the news. For example, according to Formula 2 described earlier the heat parameter of a hot word in a piece of news belonging to a news cluster is calculated using WordHotScore.

For example, the content heat parameter NewsHotScore of the news cluster can be obtained according to Formula 2 described earlier. The heat parameter HotScore of the news cluster may be obtained according to Formula 4. In some embodiments, the value of the weighting factor α in Formula 4 can range between 0.5 and 0.7.

The heat parameter of each news cluster is the average of the heat parameter of every piece of news it contains.

The frequency of each hot words appearing in each news cluster can be estimated. Several (e.g., 5) hot words that occur most frequently in the news cluster are used as the event attributes of the news cluster.

A server may be configured to determine the heat parameter and event attributes of a news cluster in accordance with the manner described above and generate hot news based on at least one of the heat parameter and event attributes of the news cluster. The server selects news in a news cluster with a high heat parameter and provides the selected news to the client device. High heat parameter may be defined as heat parameter having a value higher than a pre-determined threshold.

Alternatively, the server may be configured to identify a hot word that may be of interest to a user based on the log information of the user, select a news cluster whose event attributes include the hot word and provide the news in the news cluster to the client device.

Optionally, the server can obtain the event attributes of a news clusters that has a high heat parameter, and use the event attributes to retrieve corresponding hot news on a network or on the Internet to provide to the user.

In some embodiments, the heat parameter of a piece of news is determined by considering the timeliness of the news and the heat parameter of the content, to avoid providing or distributing out-of-date news. In addition, according to another embodiment, an initial clustering can be obtained in a heuristic manner. This can improve processing or operation efficiency. Through the technical proposals disclosed herein, user experience can be enhanced, thereby improving customer loyalty.

The technical solutions disclosed herein may be implemented as a device, a method and/or a computer program product. A computer program product may include a computer readable storage medium containing computer readable program instructions for enabling the processor to implement various aspects of the technical solutions disclosed herein.

A computer-readable storage medium may be a tangible device that can hold and store instructions used by an instruction execution device. A computer readable storage medium may be, for example, but not limited to, an electrical storage device, a magnetic storage device, an optical storage device, an electromagnetic storage device, a semi-conductor storage device, or any of the above-mentioned suitable combinations. More specific examples (non-exhaustive lists) of computer-readable storage media include: portable computer disc, a hard disk, random access memory (RAM), read-only memory (ROM), erasable programmable read-only memory (EPROM or flash memory), static random access memory (SRAM), portable compact disk read-only memory (CD-ROM), digital multifunction disk (DVD), memory rods, floppy disks, mechanical coding devices, such as perforated cards or grooves on which instructions are stored, and any suitable combination thereof. The computer-readable storage medium used herein is not interpreted as a transient signal itself, such as a radio wave or other freely propagating electromagnetic wave, an electromagnetic wave transmitted through a waveguide or other transmission medium (e.g. an optical pulse through a fiber optic cable), or an electrical signal transmitted through a wire.

The computer readable program instructions described herein may be downloaded from the computer readable storage medium to a variety of computing/processing devices, or via a network, such as the Internet, a local area network, a wide area network, and/or a wireless network, to an external computer or an external storage device. The network may include a copper transmission cable, a fiber transmission, a wireless transmission, a router, a firewall, a switch, a gateway computer, and/or an edge server. A network adaptation card or network interface in each computing/processing device receives a computer readable program instruction from the network and forwards the computer readable program instruction for storage in a computer readable storage medium in each computing/processing device.

The computer program instruction used to perform the operation of the present invention may be an assembly instruction, Instruction Set Architecture (ISA) instruction, machine instructions, machine-related instructions, microcode, firmware instructions, state setting data, or source code or target code written in any combination of one or more programming languages including object-oriented programming languages such as Smalltalk, C++, and conventional procedural programming languages such as “C” or similar programming languages. A computer readable program instruction may be executed entirely on a user computer, partly as a stand-alone software package, partly on a remote computer on the user computer, or entirely on a remote computer or server. In a case involving a remote computer, a remote computer may be connected to a user computer via any type of network, including a local area network (LAN) or a wide area network (WAN), or to an external computer (e.g. via an Internet service provider). In some embodiments, electronic circuits, such as programmable logic circuits, field programmable gate arrays (FPGA) or programmable logic arrays (PLA), may be personalized by using state information of computer readable program instructions, which may execute computer readable program instructions, thereby realizing a variety of aspects of the invention.

Each aspect of the technical solutions is described herein with reference to a flowchart and/or block diagram of a method device (system) and a computer program product according to an embodiment of the invention. It should be understood that each box in the flowchart and/or block diagram and the combination of the boxes in the flowchart and/or block diagram, and the functions thereof, can be implemented as a physical device or computer readable program instructions.

These computer-readable program instructions can be provided to general-purpose computers, a processor of a dedicated computer or other programmable data processing device, thereby producing a machine whereby these instructions are executed through a processor of the computer or other programmable data processing device, resulting in a device that implements the functions/actions specified in the flowchart and/or one or more boxes in the flowchart. These computer-readable program instructions can also be stored in a computer-readable storage medium. The instructions enable the computer, the programmable data processing device, and/or other devices to operate in a specific manner, so that the computer readable medium storing the instructions includes a manufacturing object that includes instructions that implement a variety of aspects of the function/action specified in one or more boxes in the flowchart and/or the block diagram.

You can also load computer-readable program instructions into the computer, other programmable data processing devices, or other device, a series of operation steps are performed on a computer, other programmable data processing device, or other device to generate a computer-implemented process, thereby enabling instructions executed on the computer, other programmable data processing device, or other device to implement the functions/actions specified in the flowchart and/or one or more boxes in the block diagram.

The flowcharts and block diagrams in the attached drawings show possible architectures, functions, and operations of systems, methods, and computer program products according to a variety of embodiments of the present invention. At this point, each box in a flowchart or block diagram may represent a module, program segment or part of an instruction that contains one or more executable instructions for implementing a specified logical function. In some implementations as alternatives, the functions noted in the boxes can also occur in a different order from those noted in the drawings. For example, two consecutive boxes can be executed essentially in parallel, and they can sometimes be executed in the opposite order, depending on the functionality involved. Note also that each box in a block diagram and/or flowchart, and a combination of boxes in a block diagram and/or flowchart, may be implemented with a dedicated hardware-based system that performs a specified function or action, or with a combination of dedicated hardware and computer instructions. It is known to the technicians in this field that the realization by means of hardware, software and a combination of software and hardware is equivalent.

Embodiments described herein are exemplary, and are not intended to be exhaustive or limiting. Without deviating from the scope and spirit of the described embodiments, many modifications and changes are apparent to ordinary technicians in this technical field. The choice of terms used in this article is intended to best explain the principle, practical application or technical improvement in the market of the embodiments disclosed herein, or to enable other general technicians in this technical field to understand the embodiments disclosed herein. The scope of the invention is defined by the appended claims.

What is claimed is:

1. A hot-news generation method, comprising:
determining a timeliness parameter for each of a plurality of pieces of news, wherein the timeliness parameter indicates that the heat parameter of each piece of news decreases over time;
determining a content heat parameter for each piece of news, wherein the content heat parameter is determined based on the content of the piece of news;
based on the weighted sum of the timeliness parameter and the content heat parameter of each piece of news, determining a heat parameter of the piece of news to generate hot news; and
generating hot news and transmitting the generated hot news to a client device over a network.

2. The method of claim 1, wherein the timeliness parameter of a piece of news decreases exponentially over time.

3. The method of claim 2, wherein the timeliness parameter of the piece of news is expressed as:
NewsTimeScore=exp(−r*t)
where NewsTimeScore denotes a normalized timeliness parameter, r denotes a attenuation constant, t denotes time and t=0 when the piece of news is issued.

4. The method of claim 1, wherein the content heat parameter of a piece of news is based on the heat parameter of a hot word contained in the piece of news.

5. The method of claim 4, the heat parameter of the hot word is expressed as:
$$WordHotScore ( word ) = sqrt ( \frac{num ( word )}{MaxNum} ) ,$$
wherein WordHotScore (word) denotes the heat parameter of the hot word, num (word) denotes the occurrence times of the hot word in the piece of news, and MaxNum denotes the occurrence times of the most-occurred hot word;
wherein the content heat parameter is represented as:
$$NewsHotScore ( news ) = \frac{{Σ}_{word} WordHotScore ( word )}{Num} ,$$
wherein NewsHotScore (news) denotes the content heat parameter of the piece of news, Σ_{word}WordHotScore(word) denotes the total value of the heat parameter of the hot word in the piece of news, and Num denotes the number of the hot word occurring in the piece of news.

6. The method of claim 5, wherein, the timeliness parameter is expressed as:
NewsTimeScore=exp(−r*t),
where NewsTimeScore denotes a normalized timeliness parameter, r denotes an attenuation constant, t denotes time, and t=0 when the news is issued; and
wherein the heat parameter of the news is represented as follows:
HotScore=α*NewsTimeScore+(1−α)*NewsHotScore,
where, HotScore denotes the heat parameter of the piece of news, and α is a weighting factor.

7. The method of claim 1, further comprising:
dividing the plurality of pieces of news into one or more news clusters by calculating a similarity among the plurality of pieces of news.
obtaining a heat parameter of a news cluster based on the heat parameter of each piece of news in the news cluster;
extracting one or more hot words in the news cluster as event attributes of the news cluster; and
generating hot news based on at least one of the heat parameter and the event attributes of the news cluster.

8. The method of claim 7, wherein the heat parameter of the news cluster is an average of the heat parameter of each piece of news the news cluster contains.

9. The method of claim 7, wherein one or more hot words with the highest heat value in the news cluster are extracted as event attributes of the news cluster.

10. The method of claim 7, wherein the generated hot news is a piece of news contained in the news cluster.

11. The method of claim 7, wherein the generated hot news includes the event attributes, but does not belong to the news cluster.

12. The method of claim 7, wherein the plurality of pieces of news is divided into a plurality of news clusters by:
randomly selecting a piece of news as seed news from a plurality of news that occur in a most recent time period;
searching for N pieces of news that are similar to the seed news and determining the degree of similarity S between each of the N pieces of news and the seed news.
determining M1 pieces of news whose similarity S is greater than the first threshold THs1; and
identifying the M1 pieces of news as a candidate news cluster when M1 is greater than the second threshold THm1;
for the rest news pieces, repeating steps one through four until no new news cluster is produced and K1 news clusters are obtained.

13. The method of claim 12, wherein the division of a plurality of pieces of news into a plurality of news clusters further includes:
performing a K-means clustering operation on the K1 news cluster; and
performing a filtering process after performing the K-means clustering operation on the K1 news cluster, wherein the filtering process comprises at least one of the following operations:
removing the news in each news cluster whose centroid similarity with the news cluster is lower than the third threshold THs2; and
removing the news cluster whose number of news M2 is fewer than the fourth threshold THm2.

14. The method of claim 13, where the K-means clustering operation and the filtering process are repeatedly performed to obtain K2 news clusters.

15. The method of claim 1, wherein the plurality of pieces of news is the news generated during the most recent time period.

16. A hot-news generation apparatus, including:
a device for determining a timeliness parameter for each piece of news in a plurality of news, wherein the timeliness parameter denotes a decrease in the heat parameter the news over time;
a device for determining a content heat parameter of each news, wherein the content heat parameter is a heat parameter determined based on the content of the news; and
a device for determining a heat parameter of each piece of news to generate hot news based on a weighted sum value of the timeliness parameter and the content heat parameter.

17. An electronic apparatus comprising the hot-news generation apparatus of claim 16 for generating hot news.

18. An electronic device comprising a processor and a memory, wherein the memory is used to store instructions for controlling the processor to perform the method of generating hot news of claim 1.

19. The electronic device of claim 18, wherein the electronic device is a server that transmits the generated hot news to a client device over a network.
